(19) United States
(12) Patent Application Publication
(10) Pub. No.: US 2013/0189567 A1
(43) Pub. Date: Jul. 25, 2013

(54) Lithium Ion Battery and Manufacturing Method Thereof

(71) Applicants: Minzhi YANG, Dongguan City (CN); Shaobin HE, Dongguan City (CN)

(72) Inventors: Minzhi YANG, Dongguan City (CN); Shaobin HE, Dongguan City (CN)

(21) Appl. No.: 13/355,505

(22) Filed: Jan. 21, 2012

(51) Int. Cl. H01M 2/16; H01M 10/00; H01M 2/02

(52) U.S. Cl. 429/178; 29/623.4

(57) ABSTRACT

The present application relates to a lithium ion battery, which comprises a cell and a protective plate located at the front end of the cell, an anode tab and a cathode tab arranged at the front end of the cell, and the entirety consisting of the cell and the protective plate is wrapped with a fire-proof insulating material layer. The fire-proof insulating material layer of the lithium ion battery can be directly stuck on the surface of the cell, no other parts are required to fix the fire-proof insulating material; the thickness of the fire-proof insulating material layer is just 0.01-0.09 mm, so that the cell can utilize more space, and the life is longer; the protective plate is completely wrapped by the insulating paper inside, and an insulating spacer is provided on the lateral side for the purpose of insulating and cushioning, the safety coefficient is higher.

### TECHNICAL FIELD OF THE INVENTION

The disclosure belongs to the technical field of a lithium ion battery, particularly relates to a lithium ion battery with simple structure, quick assembly, maximum capacity and high safety, in which a fire-proof insulating material layer is employed to directly wrap the cell, and a manufacturing method thereof.

### BACKGROUND OF THE INVENTION

As one kind of clean energy, due to their advantages such as high voltage, long charge/discharge cycle life, less environmental pollution and low self-discharge rate, lithium ion batteries have been widely applied in all kinds of electronic products, for example, smart phones, laptop computers, digital cameras and portable small appliances and the like.

With the increasing demands on the miniaturization of electronic products, lithium ion batteries are also correspondingly required to be thin and light, with high energy density, high capacity and high safety, simultaneously.

At present, the packaging structure of lithium ion batteries generally comprises a front cover, a rear cover, a shell and a protective plate and the like, the front cover and the rear cover are generally connected by adhesive bonding or welding. The shell is generally metallic or plastic, and the shell is generally connected with the front cover and the rear cover by adhesive bonding or welding or integrally molded by injection. Sealants are filled in gaps between the cell and the shell, between the front cover and the cell, and between the rear cover and the cell, to make the cell not shake. The front cover and the rear cover have to be injected to form a frame with a certain thickness in order to guarantee the strength, as a result, the wasted space is large, the energy density cannot be increased, and the requirement of thin lithium ion batteries cannot be met; besides, the assembly process is complicated, which is not conducive to improve the production efficiency and reduce the production cost.

In addition, these shells are not made of fire-proof materials; accidents, for example, when a short circuit occurs inside the battery, may cause fire or explosion or other dangers easily, the safety is poor.

Therefore, it is necessary to provide a lithium ion battery with simple structure, quick assembly, maximum capacity and high safety, in which a fire-proof insulating material layer is employed to directly wrap the cell.

### SUMMARY OF THE INVENTION

One purpose of the disclosure is to: in allusion to defects in the conventional art, provide a lithium ion battery with simple structure, quick assembly, maximum capacity and high safety, in which a fire-proof insulating material layer is employed to directly wrap the cell.

In order to achieve the above purpose, the following technical solution is adopted in the disclosure:

a lithium ion battery comprises a cell and a protective plate located at the front end of the cell, an anode tab and a cathode tab are arranged at the front end of the cell, and the entirety consisting of the cell and the protective plate is wrapped with a fire-proof insulating material layer. The use of the fire-proof insulating material layer can improve the fire-proofing performance, and the fire-proofing grade can reach VTM-0 (the highest grade in the UL94 plastic fire-proofing grade assessment system), further the safety can be improved. Besides, the structure is simple, and the demands of the present market can be met.

As one improvement of the lithium ion battery in the disclosure, the fire-proof insulating material is phenolic resin, aramid fiber, polycarbonic ester plastics or polyurethane. These materials not only are excellent in fire-proofing performance and light, but also have a certain hardness to protect the cell.

As one improvement of the lithium ion battery in the disclosure, the thickness of the fire-proof insulating material layer is 0.01-0.09 mm. This is because, for a same battery dimension, an ultra-thin wrapping material can make the cell utilize more space and increase the capacity of the cell.

As one improvement of the lithium ion battery in the disclosure, first insulating paper is arranged between the cell and the protective plate.

As one improvement of the lithium ion battery in the disclosure, an insulating spacer is arranged between the first insulating paper and the protective plate.

As one improvement of the lithium ion battery in the disclosure, the anode tab and the cathode tab of the cell are respectively connected with the protective plate by spot-welding.

As one improvement of the lithium ion battery in the disclosure, the spot-welded anode tab and cathode tab are respectively wound with high-temperature adhesive tapes.

As one improvement of the lithium ion battery in the disclosure, the protective plate is wrapped with second insulating paper. The protective plate is completely wrapped by the insulating material inside, and an insulating spacer is provided on the lateral side for the purpose of insulating and cushioning, the safety coefficient is higher.

As one improvement of the lithium ion battery in the disclosure, a fire-proof label is stuck outside the fire-proof insulating material layer.

With respect to the conventional art, the disclosure at least has the following advantages:

first, the fire-proof insulating material layer can be directly stuck on the surface of the cell, no other parts are required to fix the fire-proof insulating material, cost and labor are saved, and mechanically automatic mass production can be realized;

second, the thickness of the fire-proof insulating material layer is just 0.01-0.09 mm, so that the cell can utilize more space, the capacity of the battery is maximized, and the life is longer;

third, the fire-proof insulating material is a fire-proof material in accordance with the UL authentication, and the fire-proofing grade can reach VTM-0 (the highest grade in the UL94 plastic fire-proofing grade assessment system), further the safety can be improved;

fourth, the protective plate is completely wrapped by the insulating paper inside, and an insulating spacer is provided on the lateral side for the purpose of insulating and cushioning, the safety coefficient is higher.

The other purpose of the disclosure is to provide a method for manufacturing the lithium ion battery, comprising the following steps:

a first step of sticking the first insulating paper at the front end of the cell, and then sticking the insulating spacer on the first insulating paper;

a second step of spot-welding the cell on the protective plate, respectively sticking high-temperature adhesive tapes on the anode tab and the cathode tab of the cell, and then wrapping the protective plate with the second insulating paper;

a third step of wrapping the cell with the fire-proof insulating material to form a fire-proof insulating material layer, connecting the cell and the fire-proof insulating material layer by means of adhesive bonding, sticking the fire-proof label on the fire-proof insulating material layer, and finishing the assembly of the battery.

With respect to the conventional art, the method for manufacturing the lithium ion battery is simple in process, the fire-proof insulating material layer can be directly stuck on the surface of the cell, no other parts are required to fix the fire-proof insulating material, cost and labor are saved; and the obtained lithium ion batteries have advantages of high safety, small thickness, light weight and high energy density, they are suitable to be applied in small and light electronic equipment.

### BRIEF DESCRIPTION OF THE DRAWINGS

FIG. 1 shows an explosive view of the disclosure;

FIG. 2 shows a solid diagram of the front side of the disclosure; and

FIG. 3 shows the solid diagram of the back side of the disclosure.

### DETAILED DESCRIPTION OF THE INVENTION

The disclosure will be further described in details below with reference to embodiments and drawings, however, the embodiments of the disclosure are not limited hereto.

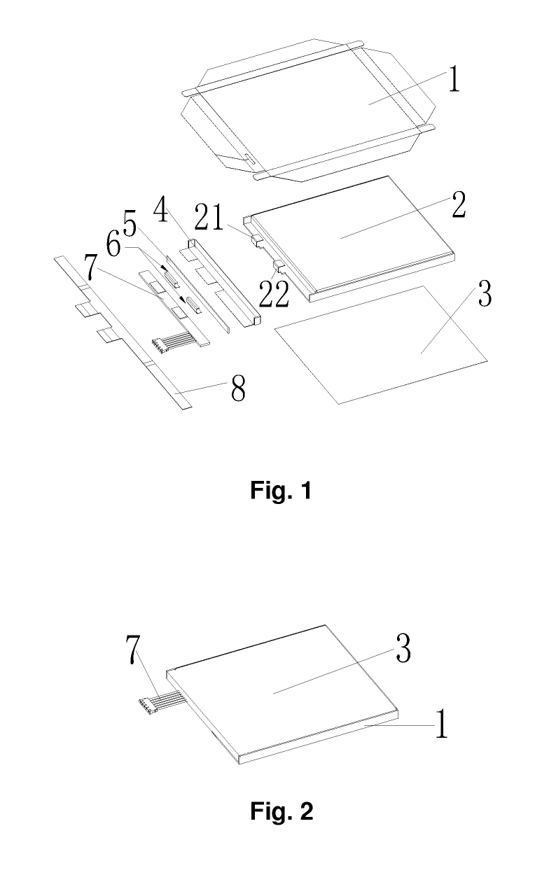

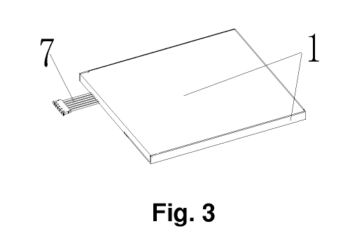

As shown in FIG. 1, FIG. 2 and FIG. 3, the lithium ion battery in the disclosure comprises a cell 2 and a protective plate 7 located at the front end of the cell 2, an anode tab 21 and a cathode tab 22 are arranged at the front end of the cell 2, and the entirety consisting of the cell 2 and the protective plate 7 is wrapped with a fire-proof insulating material layer 1. Wherein, the fire-proof insulating material is phenolic resin, aramid fiber, polycarbonic ester plastics or polyurethane, these materials not only are excellent in fire-proofing performance and light, but also have a certain hardness to protect the cell 2. The thickness of the fire-proof insulating material layer 1 is preferably 0.01-0.09 mm, so that the cell 2 can utilize more space, the capacity of the battery is maximized, and the life is longer. A fire-proof label 3 is stuck outside the fire-proof insulating material layer 1.

First insulating paper 4 is arranged between the cell 2 and the protective plate 7, an insulating spacer 5 is arranged between the first insulating paper 4 and the protective plate 7, the anode tab 21 and the cathode tab 22 of the cell 2 are respectively connected with the protective plate 7 by spot-welding, and the spot-welded anode tab 21 and cathode tab 22 are respectively wound with high-temperature adhesive tapes 6. And the protective plate 7 is wrapped with second insulating paper 8.

During assembling, the following steps are included:

first step: the first insulating paper 4 is stuck at the front end of the cell 2, and then the insulating spacer 5 is stuck on the first insulating paper 4;

second step: the cell 2 is spot-welded on the protective plate 7, high-temperature adhesive tapes 6 are respectively stuck on the anode tab 21 and the cathode tab 22 of the cell 2, and then the protective plate 7 is wrapped with the second insulating paper 8;

third step: the cell is wrapped with the fire-proof insulating material to form a fire-proof insulating material layer 1, the cell 2 and the fire-proof insulating material layer 1 are connected by means of adhesive bonding, the fire-proof label 3 is stuck on the fire-proof insulating material layer 1, and the assembling ends.

In conclusion, the method for manufacturing the lithium ion battery is simple in process, the fire-proof insulating material layer can be directly stuck on the surface of the cell, no other parts are required to fix the fire-proof insulating material, cost and labor are saved; and the obtained lithium ion batteries have advantages of high safety, small thickness, light weight and high energy density, they are suitable to be applied in small and light electronic equipment.

According to the disclosure and instruction of the description, technicians in the field may have variations and modifications for the above embodiment. Therefore, the disclosure is not limited to the specific embodiment disclosed and described above, any modifications and variations of the disclosure should also be included within the protection scope defined in the claims of the disclosure. In addition, although some specific items are used in the description, these items are just provided for explaining and form no limit to the disclosure.

What is claimed is:

1. A lithium ion battery, comprising a cell and a protective plate located at the front end of the cell, an anode tab and a cathode tab arranged at the front end of the cell, wherein the entirety consisting of the cell and the protective plate is wrapped with a fire-proof insulating material layer.

2. The lithium ion battery according to claim 1, wherein the fire-proof insulating material is phenolic resin, aramid fiber, polycarbonic ester plastics or polyurethane.

3. The lithium ion battery according to claim 1, wherein the thickness of the fire-proof insulating material layer is 0.01-0.09 mm.

4. The lithium ion battery according to claim 3, wherein first insulating paper is arranged between the cell and the protective plate.

5. The lithium ion battery according to claim 4, wherein an insulating spacer is arranged between the first insulating paper and the protective plate.

6. The lithium ion battery according to claim 5, wherein the anode tab and the cathode tab of the cell are respectively connected with the protective plate by spot-welding.

7. The lithium ion battery according to claim 6, wherein the spot-welded anode tab and cathode tab are respectively wound with high-temperature adhesive tapes.

8. The lithium ion battery according to claim 7, wherein the protective plate is wrapped with second insulating paper.

9. The lithium ion battery according to claim 8, wherein a fire-proof label is stuck outside the fire-proof insulating material layer.

10. A method for manufacturing the lithium ion battery, comprising the following steps:
a first step of sticking the first insulating paper at the front end of the cell, and then sticking the insulating spacer on the first insulating paper;
a second step of spot-welding the cell on the protective plate, respectively sticking high-temperature adhesive tapes on the anode tab and the cathode tab of the cell, and then wrapping the protective plate with the second insulating paper;
a third step of wrapping the cell with the fire-proof insulating material to form a fire-proof insulating material layer, connecting the cell and the fire-proof insulating material layer by means of adhesive bonding, sticking the fire-proof label on the fire-proof insulating material layer, and finishing the assembly of the battery.
